(19) United States
(12) Patent Application Publication
(10) Pub. No.: US 2014/0066192 A1
(43) Pub. Date: Mar. 6, 2014

(54) SYSTEMS AND METHODS FOR CREATING AND MAINTAINING AN INVENTORY LIST AND VERIFYING COMPONENTS OF GAMING EQUIPMENT

(71) Applicants: Zachary Hollis, Denver, CO (US); Chris Van Emmerik, Westminster, CO (US)

(72) Inventors: Zachary Hollis, Denver, CO (US); Chris Van Emmerik, Westminster, CO (US)

(73) Assignee: GAMING LABORATORIES INTERNATIONAL, LLC, Lakewood, NJ (US)

(21) Appl. No.: 13/602,896

(22) Filed: Sep. 4, 2012

(51) Int. Cl. G07F 17/32

(52) U.S. Cl. CPC G07F 17/3241
USPC 463/29

(57) ABSTRACT

Systems and methods for authenticating an inventory list of the components installed on electronic gaming devices, including receiving, from an input device, an input signal indicating the identity and location of a gambling device, and an electronic signature of each installed component, receiving the electronic signature and software components which should be installed on the gambling device, comparing electronic signature of the components. If the electronic signature of the components do not match the received electronic signature of the what should be installed on the gambling device, and sending a confirmation to the inventory database component indicating the correct software is not installed.

### BACKGROUND

1. Statement of the Technical Field

Embodiments include systems and methods for creating and maintaining an inventory list, and verifying installed hardware and software components of gaming equipment.

2. Description of the Related Art

For many years casino operators and regulators have struggled to have a useful system to use to track installed components such as the software and hardware that comprises the slot machines on the floor of a casino. Furthermore, relating these components to their regulatory approval status in multiple jurisdictions can be a tedious and sometimes impossible task.

Historically, creating and maintaining an inventory list of the installed components in a casino is a largely manually task, and as a result, prone to errors. The inventory list is often created under the restraints of an accounting system “slot file” and does not have flexibility regarding the information that can be manually entered.

A system that can solve all of these problems by utilizing a number of new technologies and coupling the results with a pre-existing unique knowledgebase is desirable.

### SUMMARY

Systems and methods for authenticating an inventory list of the components installed on casino gambling devices and/or Internet gaming applications, including receiving, from an input device, an input signal indicating the identity and location of a gambling device, and an electronic signature of each installed component, receiving the electronic signature and software components which should be installed on the gambling device, comparing electronic signature of the components, are provided. If the electronic signature of the components do not match the received electronic signature of what should be installed on the gambling device, and sending a confirmation to the inventory database component indicating the correct software has been installed.

In an aspect of the invention, systems and methods are provided for generating one or more messages for a casino operator indicating problem software installations on one or more gambling devices. These include receiving into an inventory database component the identity and signature of all components installed on the one or more gambling device, the inventory database component comprising a database and an associated electronic circuit, comparing, by the electronic circuit, the received identity and signature of all installed components with the identity and signature of the approved components for the jurisdiction, and reporting, by the electronic circuit, to the casino operator all components whose signature does not match the signature of an approved component.

In additional aspects of the invention, a live video of the gambling device may be captured using a camera associated with the electronic circuit, and the captured video may be streamed to a live video feed.

### BRIEF DESCRIPTION OF THE DRAWINGS

Embodiments will be described with reference to the following drawing figures, in which like numerals represent like items throughout the figures, and in which:

FIG. 1 is a schematic system diagram of an exemplary system that is useful for understanding the present invention.

FIG. 2 is a block diagram of an exemplary communication device that is useful for understanding the present invention.

FIG. 3 is a block diagram of an exemplary server that is useful for understanding the present invention.

FIG. 4 provides a user interface screen an exemplary implementation that is useful for understanding the present invention.

FIG. 5 provides a user interface screen an exemplary implementation that is useful for understanding the present invention.

FIG. 6 provides a user interface screen an exemplary implementation that is useful for understanding the present invention.

FIG. 7 provides a user interface screen an exemplary implementation that is useful for understanding the present invention.

FIG. 8 provides a user interface screen an exemplary implementation that is useful for understanding the present invention.

FIG. 9 provides a user interface screen an exemplary implementation that is useful for understanding the present invention.

### DETAILED DESCRIPTION

The present invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

The present invention provides a system and method for creating and maintaining an inventory list of the components installed on casino gambling devices, such as, but not limited to slot machines, integrating multiple technologies and coupling the results with a unique knowledgebase. An embodiment of the invention will be described in reference to a system under development at Gaming Laboratories International, LLC (hereinafter, “GLI”), although it is understood that the systems and methods described herein may be developed by any entity and may employ alternative sub-systems without departing from the scope of the invention. This system advantageously utilizes:
Communication protocol that can query a device for components and signatures to automatically determine the components in a game , or on an internet game server, while verifying their authenticity;
Centralized storage of all the information allowing authorized persons anywhere to view and use the data;
Automatic association of all of the data to data maintained in a unique knowledgebase of specific and maintained information; and,
Dynamic database creation to allow users to automatically import the specific information for which they are concerned about tracking.

In addition to these advantageous features, embodiments of the present invention may offer additional advantages. Some advantages are particularly useful with embodiments used in a cloud computing, or “cloud” environment. Additional advantages include, but are not limited to any of the following.

A Slot File Upload provides the ability to automatically upload any spreadsheet containing a gaming machine file and associated dynamic information into a database tied to the inventory database 102.

An Inventory Tracker provides the ability to track and maintain information associated to the machines on the casino floor from the personalized database.

A Component Tracker provides the ability to monitor the approval status of all of the components setup in the system.

Support for communication protocol that can query a device for components and signatures with a customized seed provides the ability for the regulator, or operator, to utilize their own seed to generate a unique signature and to upload the results to the inventory database 102 server.

Activity Log, Audit Tracking and Sealing functionality provides the ability for all verification and inventory activity at a machine to be track in the inventory database.

Automatic Notifications of revocations, moves, and the addition and removal of components provides the ability to get emailed notifications when the status changes for a component in the database, activity is performed on a machine, or a notification is released by a manufacturer.

Attachment Uploads allows an agent to go to the machine with a GLI Mobile™ device, select the slot machine they are at, take a picture of an issue on the floor, and upload the picture under the record for that machine. Other files can also be uploaded such as incident reports and meal cards.

Automatic PAR Sheets and Pay Screens automatically link the payscreens and par sheets for each game making them readily available under the record for the machine on the floor.

Task Scheduler allows tasks to be assigned to other users on the system or “cloud”. This could include tasks such as verify machine, investigate incident, and tape media.

Customizable reports may be generated relating all of the uploaded and stored data together.

User Management—Add additional users, control access—allows for the addition of personnel and the ability to manage roles associated to those personnel. This will also facilitate the sharing of information between personnel with built in security.

Mobile device support allows the user to receive notifications specific to the manufacturer of a particular gaming device, or application, relating to the acceptablility of the device and/or content, notifications regarding the change in regulatory status of gaming devices and/or content, and other configurable alerts on mobile devices.

Integration of a communication protocol that facilitates the communication with a gaming device, or server hosting gaming content, which allows for the enumeration and/or verification of the content on that device or server into a mobile application that can be run from a phone, tablet, or other mobile device. This allows for the use of the communication protocol and the associated centralized repository features to be used with mobile devices. This may include a wireless device utilizing the communication protocol through Bluetooth or USB.

Automatic Machine Identification allows for a game to be automatically identified. Initially this could be done through the use barcode stickers, but eventually through a Bluetooth or custom cable in the game.

GPS Tagging allows the ability to tag the GPS location of a game via a mobile device.

Electronic MEAL cards allows all activity associated with a game to be logged on a Meal Card through a mobile device. This will allow for real time meal cards and employee activity tracking.

Live Video Feeds Using mobile devices allows a user to activate a live video feed from a specified location on the casino floor using a mobile device. This could help with the evaluation of game issues on the floor from a remote location.

Automatic Integration to backend systems allows for real time updates based on changes to a slot file on the system itself. The feature may need to be rolled out in two phases. The first will require a GLI service that resides on the accounting system that can read the database and communicate it to the centralized server. The second can leverage the use of the extensions made to existing communication protocols.

Automatic verification of gaming content via signatures using a protocol designed to communicate to the devices through a gaming or casino system from another vendor will allow a user to verify the games on the floor from the centralized server.

Ability to Generate and Download Binary Images used for the verification of gaming content provides lottery operators the ability to generate and download binary images associated to their updated slot files on the tracking system when gaming content changes.

Ability to Download Additional Lottery Specific Meta-data is useful for some jurisdictions that require additional files that are to be loaded on the lottery system

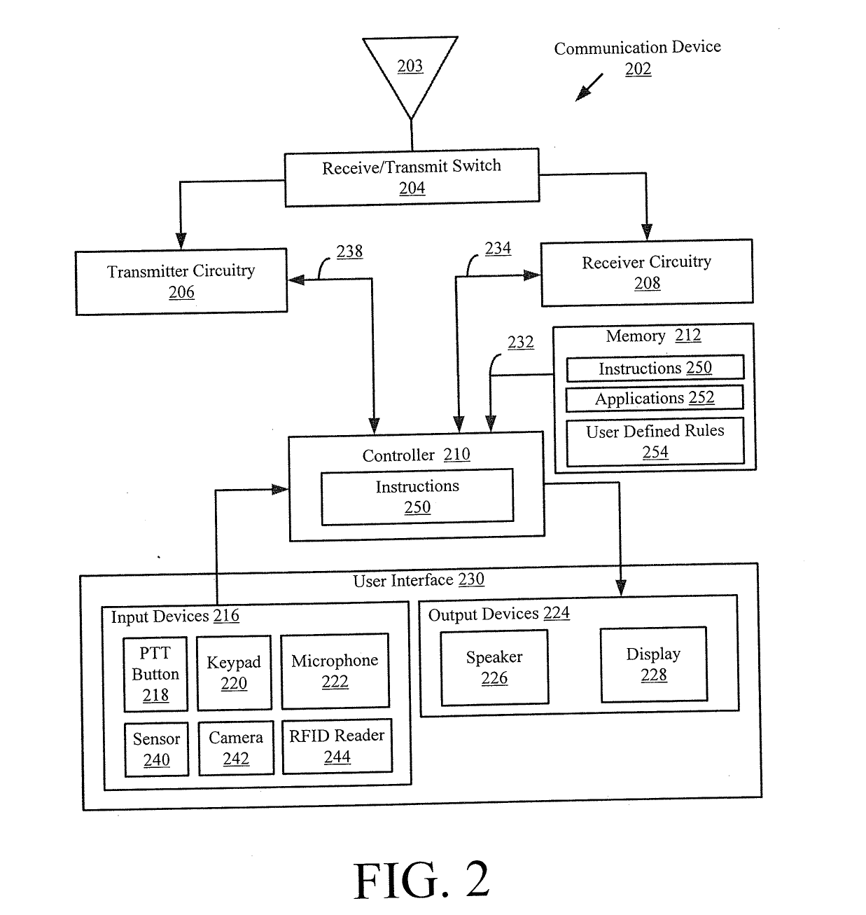

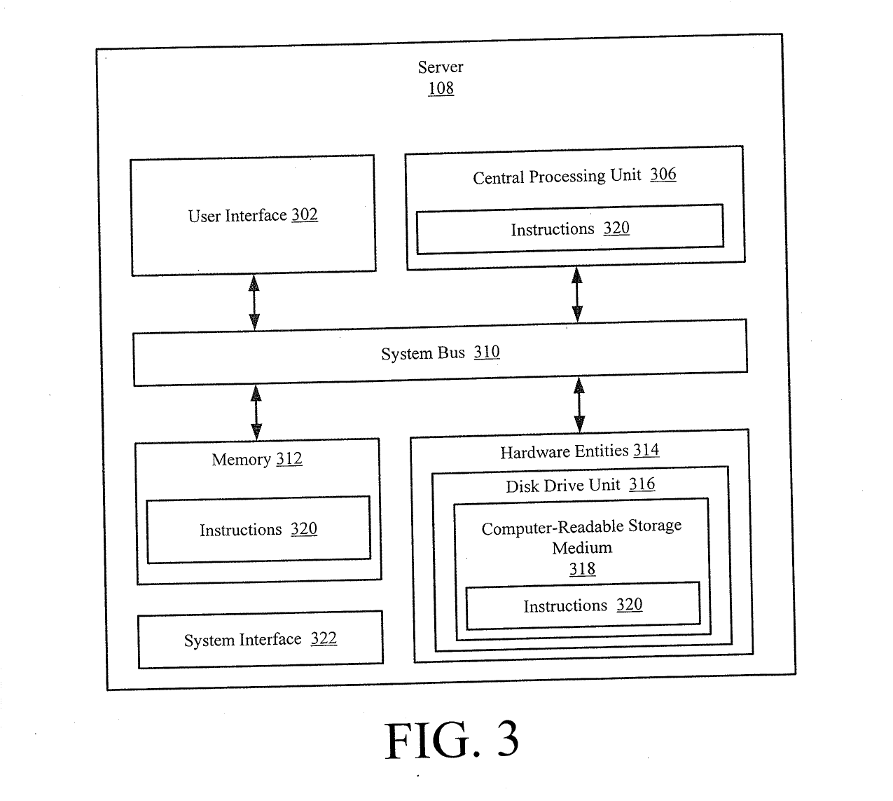

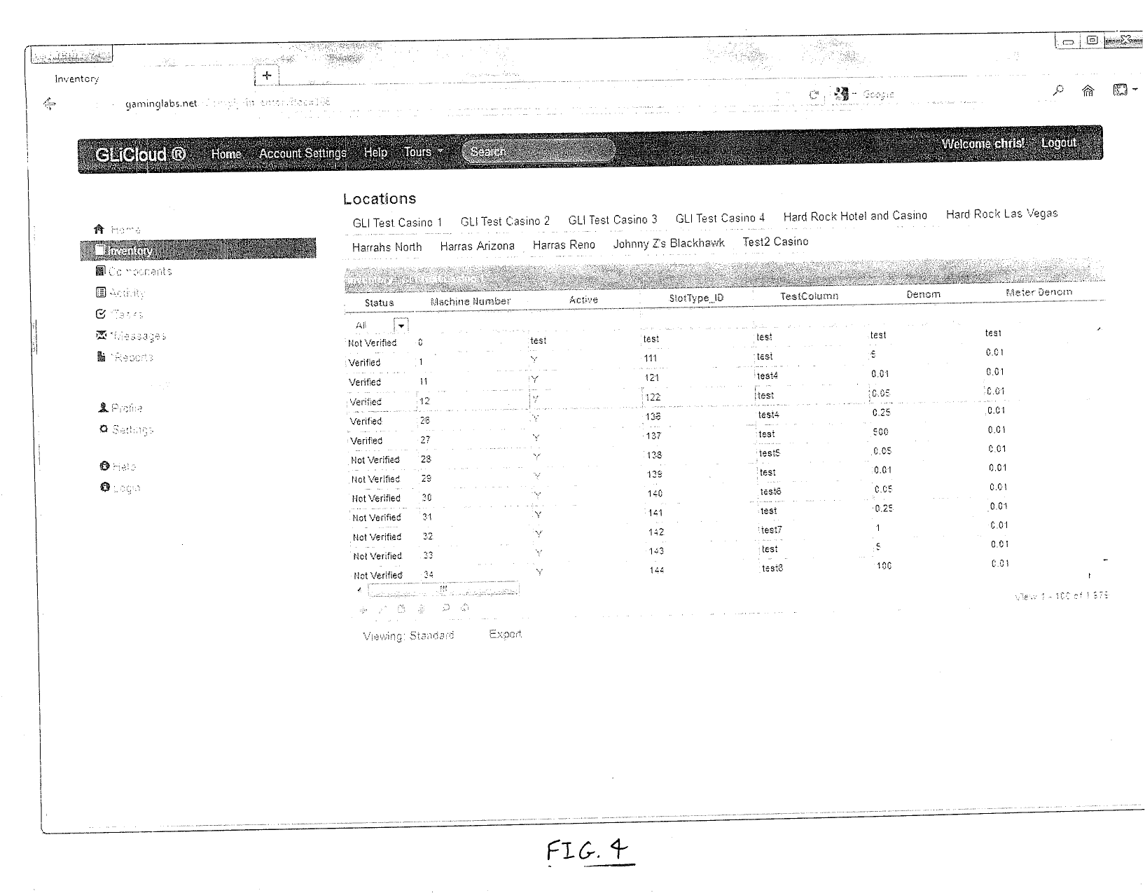

Although described in terms of various components used to implement the methods, the present invention can be used in a variety of system configurations, such as, but not limited to, mobile phone applications, portable computer applications, PDA applications, and the like. Also, various system components may be combined into a few or even one hardware component(s) without affecting overall functionality. Exemplary implementing system embodiments of the present invention will be described below in relation to FIGS. 2-3. Exemplary method embodiments of the present invention will be described below in relation to FIGS. 4-9.

### Exemplary Systems Implementing The Present Invention

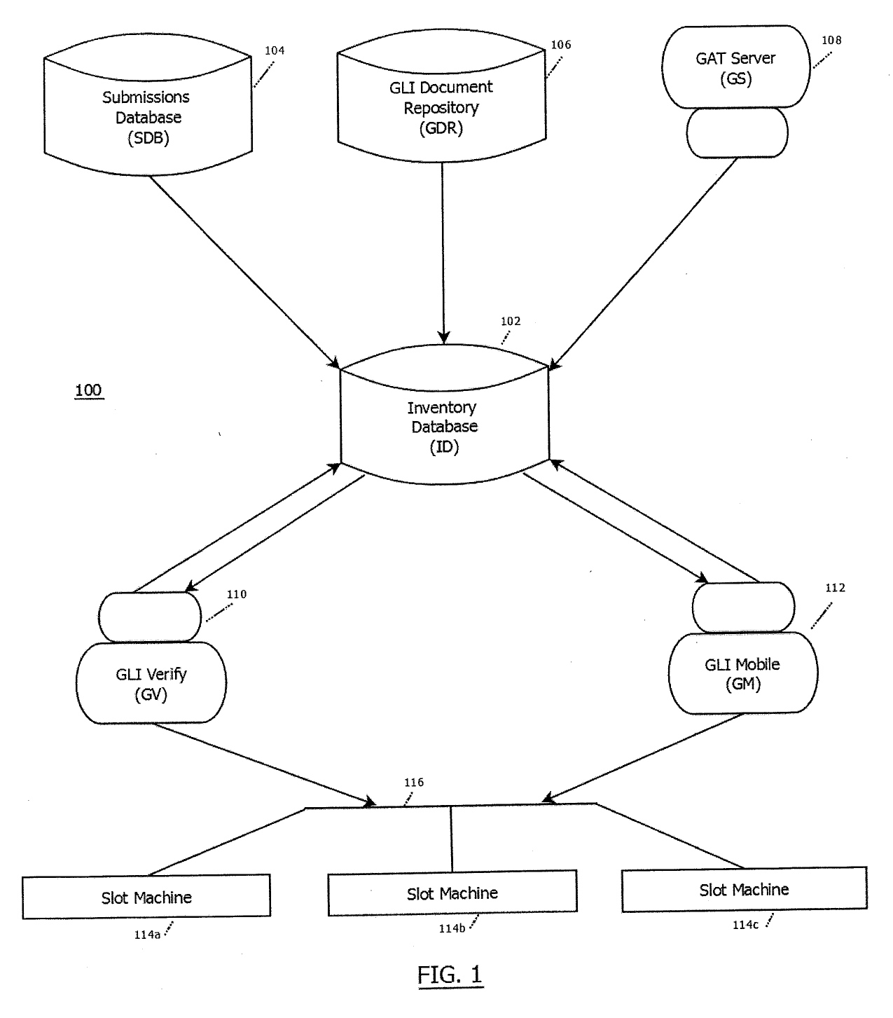

Referring now to FIG. 1, there is provided a block diagram of an exemplary system 100 that is useful for understanding various embodiments of the present invention. The system 100 comprises a mobile application component 112, a verification component 110, a GAT server 108, an inventory database component 102, a submissions database component 104, and a document repository component 106. Also depicted are exemplary gaming machines 114a, 114b and 114c, as well as optional gaming machine interconnectivity 116.

The mobile application component 112 is a mobile application that allows a user to track the programs approved in their jurisdiction and their associated approval status from their phone. This information may then be used with the inventory tracking system to allow regulators and casino operators to track the approved programs and relate it to the actual programs on the casino floor. In an embodiment of the invention, GLI MOBILE™ is a mobile application component 112 deployed on a mobile device 202, such as, but not limited to the mobile device 202 depicted in FIG. 2.

The verification component 110 is a utility that is used by regulators and operators around the world to verify slot machine programs by generating a signature that is representative of the game itself. This signature can then be used to validate the program against a signature generated by GAT Server 108. The signature communicates that the program is in fact the program that was validated to comply with the applicable regulations. In an embodiment, the verification component 110 is configured to also support the a protocol to communicate with the gaming application which is used by games to communicate through a communication port information including the loaded software. The communication protocol can also be used to request the game generate and return a signature that represents each of the pieces of software that it contains. In one embodiment of the invention, the verification component 110 is provided by GLI VERIFY™.

To facilitate a unique signature for each regulator, a GAT Server 108 is provided to allow the signature generated by the game to be “seeded” with a unique key. This eliminates the possibility of a game just keeping a stored signature and retrieving it when a request is received by GLI Verify. This provides a level of comfort to a regulator but also requires a tedious step, which has to be performed in advance, of determining what the correct signature should be from the program if it uses the unique “seed”.

An embodiment of the invention uses a protocol to communicate game components and signatures, hereinafter “GAT protocol”. For example, GAT 3.50.1 protocol—which was created by GSA in conjunction with GLI to facilitate the communication of a slot machine's content and the content's associated signatures—may be employed.

GLI has developed a system to eliminate this step. We have created a repository of images that represent every piece of software that can reside in a slot machine. Using this repository we have created a database of Meta information associated to the images and created services that can generate signatures of all of the programs for preselected “seed” values.

Gaming machine content should be tied to the actual slot machines on the casino floors. To achieve this, an inventory database component 102 is created for each casino containing all of the information associated to every machine in the casino.

One step in the process of creating an inventory is determining all of the programs that are in a gaming machine. Most casino inventory lists are designed to track a single machine on the floor and lack the concept of the machine containing a number of programs. Furthermore, gathering and entering this information is a difficult and tedious process.

The Submissions database 104 is used to maintain all of the gaming application specific information from all software approvals GLI performs as well as the regulatory approval status of the components. This includes the type of software, the jurisdictions it is approved in, and its representative signatures.

GLI keeps all of the information regarding the software and hardware in a centralized location, a GLI Document Repository 106. This database includes documentation on how games behave, images relating to each game, testing results, par sheets, and payglass.

In an embodiment, the UI presentation server provides the user interface to the communication device 202 over the Internet. Information input through the communication device 202 is forwarded to the application server 106 for processing and/or storage in the database 114. The cache server 112 saves frequently-used data for fast access as needed.

The database 104 component may be a stand-alone database server, a persistent drive and operating software associated with the application server 106, a cloud-computing database “cloud”, or may be implemented by other means.

Referring now to FIG. 2, there is provided a more detailed block diagram of the communication device 202. The communication device 202 will be described herein as comprising a mobile phone or a smart phone. However, the present invention is not limited in this regard. For example, the communication device can alternatively comprise a PDA, a tablet Personal Computer (“PC”), or the like.

Notably, the communication device 202 can include more or less components than those shown in FIG. 2. For example, the communication device 202 can include a wired system interface, such as a universal serial bus interface (not shown in FIG. 2). However, the components shown are sufficient to disclose an illustrative embodiment implementing the present invention.

As shown in FIG. 2, the communication device 202 comprises an antenna 202 for receiving and transmitting Radio Frequency (RF) signals. A receive/transmit (Rx/Tx) switch 204 selectively couples the antenna 202 to the transmitter circuitry 206 and receiver circuitry 208 in a manner familiar to those skilled in the art. The receiver circuitry 208 demodulates and decodes the RF signals received from a network (e.g., the network 100 of FIG. 1) to derive information therefrom. The receiver circuitry 208 is coupled to a controller 210 via an electrical connection 234. The receiver circuitry 208 provides the decoded RF signal information to the controller 210. The controller 210 uses the decoded RF signal information in accordance with the function(s) of the communication device 202. The controller 210 also provides information to the transmitter circuitry 206 for encoding and modulating information into RF signals. Accordingly, the controller 210 is coupled to the transmitter circuitry 206 via an electrical connection 238. The transmitter circuitry 206 communicates the RF signals to the antenna 202 for transmission to an external device (e.g., network equipment of network 100 of FIG. 1).

The controller 210 stores the decoded RF signal information in a memory 212 of the communication device 202. Accordingly, the memory 212 is connected to and accessible by the controller 210 through an electrical connection 232. The memory 212 can be a volatile memory and/or a non-volatile memory. For example, the memory 212 can include, but is not limited to, a Random Access Memory (RAM), a Dynamic Random Access Memory (DRAM), a Static Random Access Memory (SRAM), Read-Only Memory (ROM) and flash memory. The memory 212 can also have stored therein the software applications 252 and user-defined rules 254.

The software applications 252 may include, but are not limited to, applications operative to provide telephone services, network communication services, Internet connectivity and access services, commerce services, email services, web based services, electronic calendar services, as well as software providing the functionality required to operate the methods of the present invention.

As shown in FIG. 2, one or more sets of instructions 250 are stored in the memory 212. The instructions 250 can also reside, completely or at least partially, within the controller 210 during execution thereof by the communication device 202. In this regard, the memory 212 and the controller 210 can constitute non-transient machine-readable media. The term “machine-readable media”, as used here, refers to a single medium or multiple media that store the one or more sets of instructions 250. The term “machine-readable media”, as used here, also refers to any medium that is capable of storing, encoding or carrying the set of instructions 250 for execution by the communication device 202 and that cause the communication device 202 to perform one or more of the methodologies of the present disclosure.

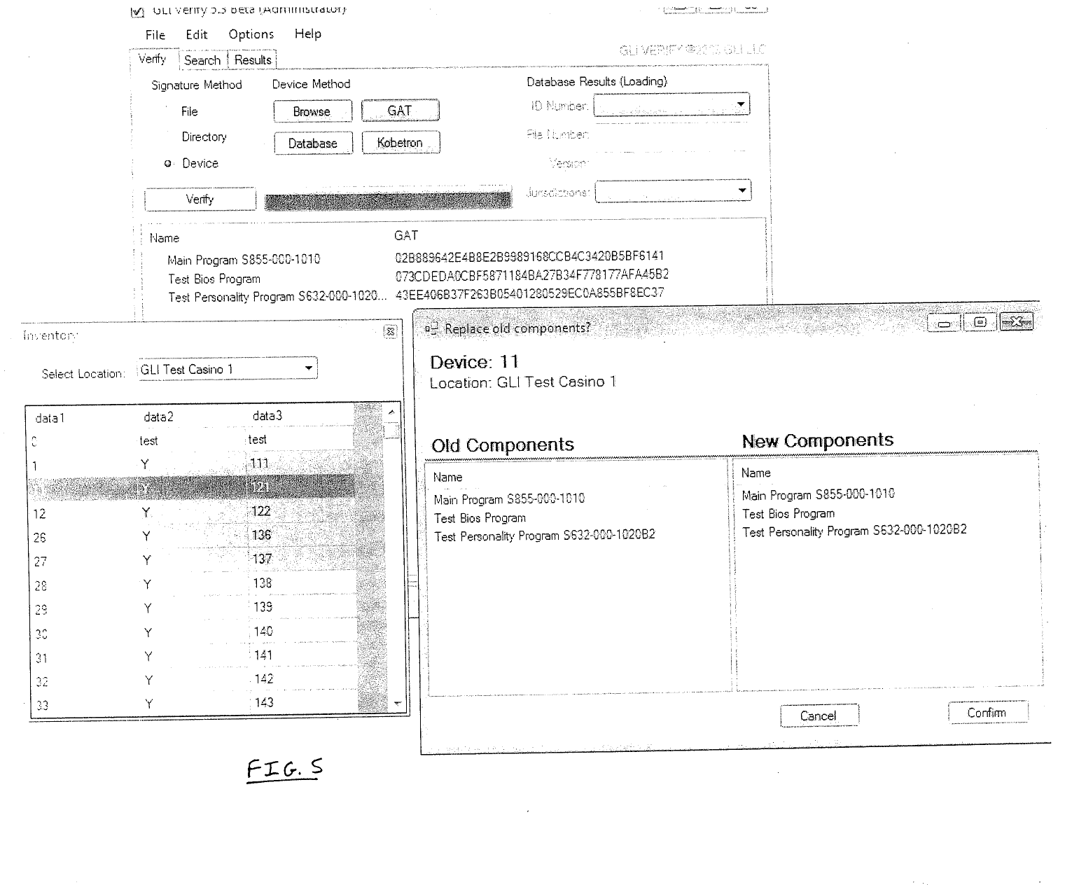

The controller 210 is also connected to a user interface 230. The user interface 230 is comprised of input devices 216, output devices 224, and software routines (not shown in FIG. 5) configured to allow a user to interact with and control software applications 252 installed on the computing device 202. Such input and output devices respectively include, but are not limited to, a display 228, a speaker 226, a keypad 220, a directional pad (not shown in FIG. 5), a directional knob (not shown in FIG. 2), a microphone 222, a Push-To-Talk (“PTT”) button 218, sensors 240, a camera 242 and a Radio Frequency Identification (“RFID”) reader 244.

Referring now to FIG. 3, there is provided a more detailed block diagram of a server 106, 108, 112 of FIG. 1 that is useful for understanding the present invention. As shown in FIG. 3, the server 106, 108, 112 comprises a system interface 322, a user interface 302, a Central Processing Unit (CPU) 306, a system bus 310, a memory 312 connected to and accessible by other portions of server 108 through system bus 310, and hardware entities 314 connected to system bus 310. At least some of the hardware entities 314 perform actions involving access to and use of memory 312, which can be a Random Access Memory (RAM), a disk driver and/or a Compact Disc Read Only Memory (CD-ROM). Some or all of the listed components 302-322 can be implemented as hardware, software and/or a combination of hardware and software. The hardware includes, but is not limited to, an electronic circuit.

The server 106, 108, 112 may include more, less or different components than those illustrated in FIG. 3. However, the components shown are sufficient to disclose an illustrative embodiment implementing the present invention. The hardware architecture of FIG. 3 represents one embodiment of a representative server configured to provide supporting services to a user of a communication device (e.g., communication device 202 of FIG. 1). For example, the server 106, 108, 112 may implement a method for lookup of available components and signatures for the relevant jurisdiction using an external database in communication with the server 106, 108, 112 (database not depicted), or the server may use its existing disk drive unit 316, computer-readable storage medium 318 and other facilities to store auction information, as needed. It may also provide dosage factor data to the communication device 202, as needed. Exemplary embodiments of said method will be described below in relation to FIGS. 4-5.

Hardware entities 314 can include microprocessors, Application Specific Integrated Circuits (ASICs) and other hardware. Hardware entities 314 can include a microprocessor programmed for facilitating the provision of the automatic software function control services to a user of the communication device (e.g., communication device 202 of FIG. 1). In this regard, it should be understood that the microprocessor can access and run various software applications (not shown in FIG. 3) installed on the server 106, 108, 112. Such software applications include, but are not limited to, database applications.

As shown in FIG. 3, the hardware entities 314 can include a disk drive unit 316 comprising a computer-readable storage medium 318 on which is stored one or more sets of instructions 320 (e.g., software code or code sections) configured to implement one or more of the methodologies, procedures, or functions described herein. The instructions 320 can also reside, completely or at least partially, within the memory 312 and/or within the CPU 306 during execution thereof by the server 108. The memory 312 and the CPU 306 also can constitute machine-readable media. The term “machine-readable media”, as used here, refers to a single medium or multiple media (e.g., a centralized or distributed database, and/or associated caches and servers) that store the one or more sets of instructions 320. The term “machine-readable media”, as used here, also refers to any medium that is capable of storing, encoding or carrying a set of instructions 320 for execution by the server 106, 108, 112 and that cause the server 106, 108, 112 to perform any one or more of the methodologies of the present disclosure.

In a preferred embodiment of the invention, the system is logically comprised of a number of components. Several of these components are already tools that are provided by GLI to manufacturers, regulators, and operators. Each component is described with respect to the particular function(s) it performs. Each provides a fundamental piece of the entire system and adds a unique value.

### Exemplary Methods

Referring now to FIGS. 4-9, there is provided a series of diagrams that illustrate user interfaces depicting the results of methods for creating and maintaining an inventory list of the components installed on casino gambling devices. It is understood that the processes used in these embodiments may vary somewhat without departing significantly from the scope of the invention.

Generally, the process for the inventory tracking system maybe be simplified to 3 steps: Input Casino Data, Input Program Data, and Associate Data to GLI Information.

The input of casino data in a preferred embodiment of the invention may be performed by reading the data in a spreadsheet and dynamically creating a database based on the information in the spreadsheet. Many regulators and operators are currently using spreadsheets, so using already-existing spreadsheet data provides for efficiency. Alternative methods of inputting casino data may also be employed, either to augment or correct data imported from an existing spreadsheet or as a primary means of obtaining the data. FIG. 4 is an exemplary screenshot of casino data collected from a spreadsheet.

Next, program data is input. This step of inputting the data is potentially the most time consuming and error prone. In an embodiment of the system, a verification component 110, such as GLI VERIFY™ may be used on the casino floor to both validate the programs in the machine and relate them to the inventory system, essentially by querying the game to report what it contains.

In a typical scenario, the agent from the regulatory body, or the casino operator, hereinafter “user”, selects the machine they are validating by selecting it from the inventory window, such as depicted in FIG. 4. The game will then be presented to the regulator/operator by a unique identifier selected when the information was imported. This unique identifier may usually be the serial number of the cabinet or the asset number associated to the cabinet by the accounting system, or the like.

Next, the operator or regulatory body may connect an interface cable between the game and their laptop and select verify on the verification component 110 application. Once the game communicates the information, the verification component 110 relates it to information already downloaded to the laptop. In an embodiment of the invention, this information is the data maintained in the GLI Document Repository 106 and/or Submissions Database 104, as well as in the Inventory Database Component 102 and the unique GAT signatures GLI maintains on its GAT server.

Once the verification component 110 has communicated that the programs in the slot machine are known and approved, the user is asked if they want to input this information regarding the components in the game into the inventory database. If the user chooses to import the data it is will be stored locally and uploaded to the GLI server when the user chooses. FIG. 5 depicts a user interface displaying the collected data.

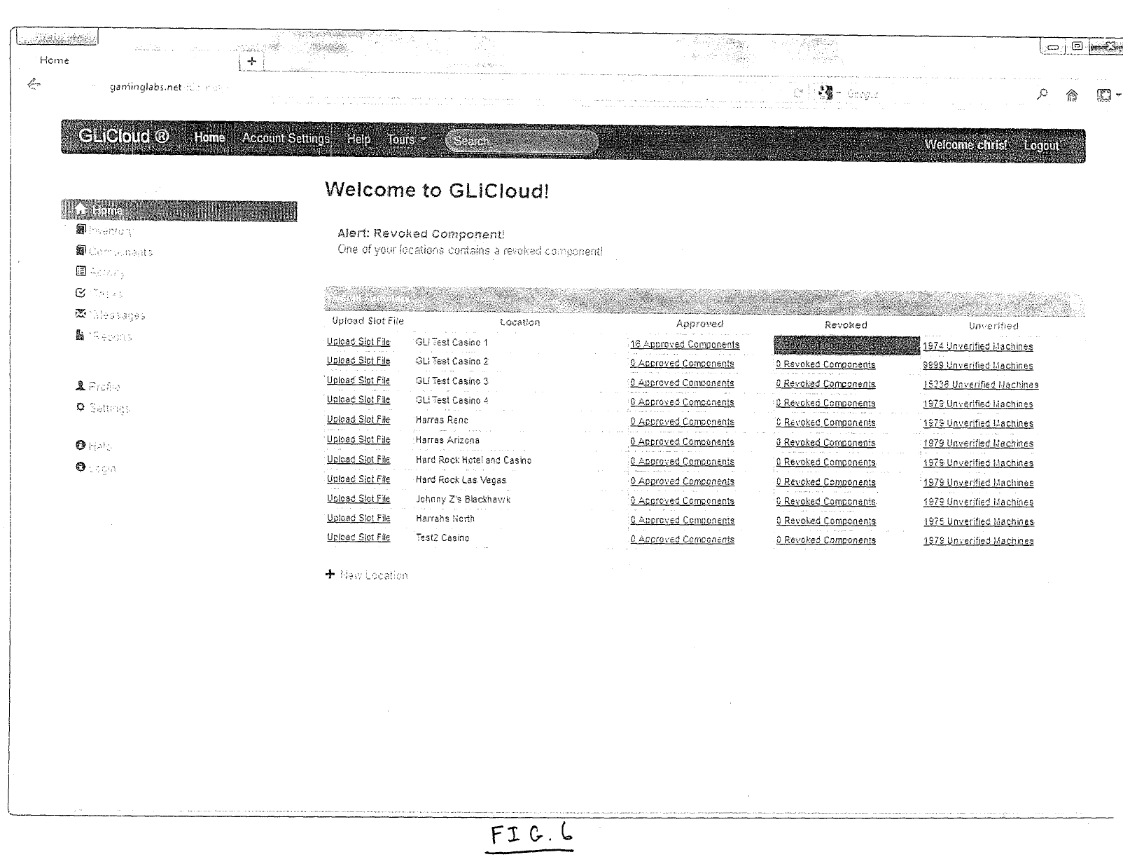

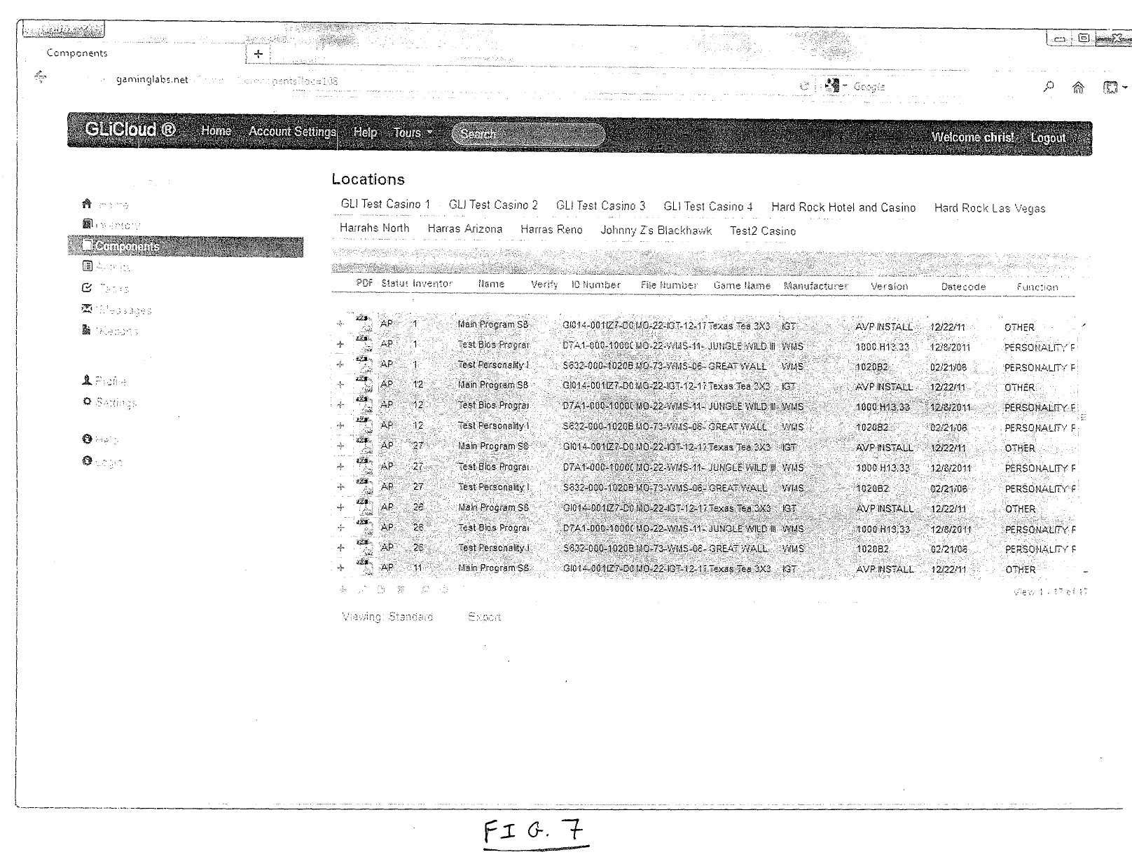

Next, the Casino Data is associated with GLI Information and stored in the Inventory Database Component 102. In an embodiment of the invention, once the information has been uploaded it may be viewed from a secure website. The storing of the information on a server potentially allows multiple authorized users to see the up-to-date status of the gaming system components remotely on their computers and mobile devices. FIG. 6 is a screenshot of an exemplary display of such information for one machine component. The information may be accessed for one machine component or for all components of a machine. FIG. 7 depicts an exemplary screenshot featuring a list of available machine components to view.

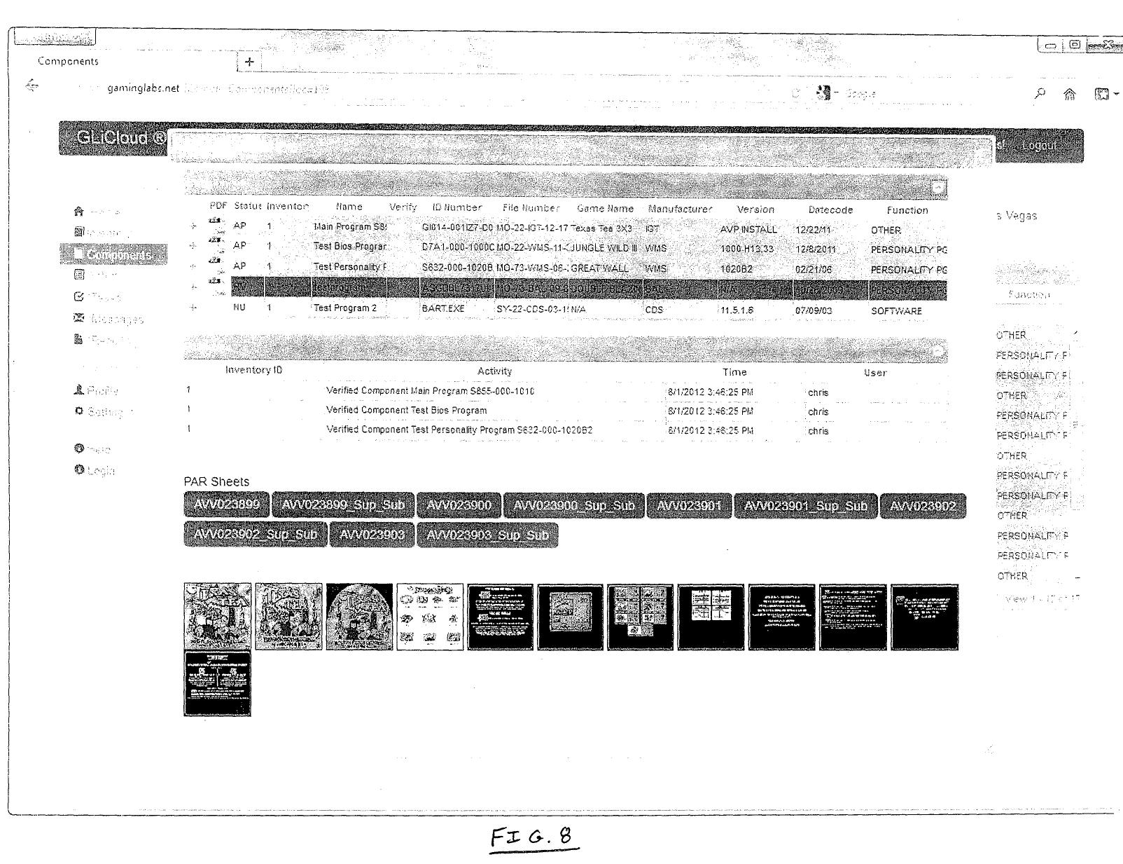

Since the components and their data are stored on the Inventory Database Component 102 and Submissions Database 104 they can be associated with all of the information the Document Repository 106 already has regarding the components. This information generally relates both to the regulatory status of the components and meta-information such as payscreens, parsheets, and payback percentages, such as partially depicted the screenshot of FIG. 8

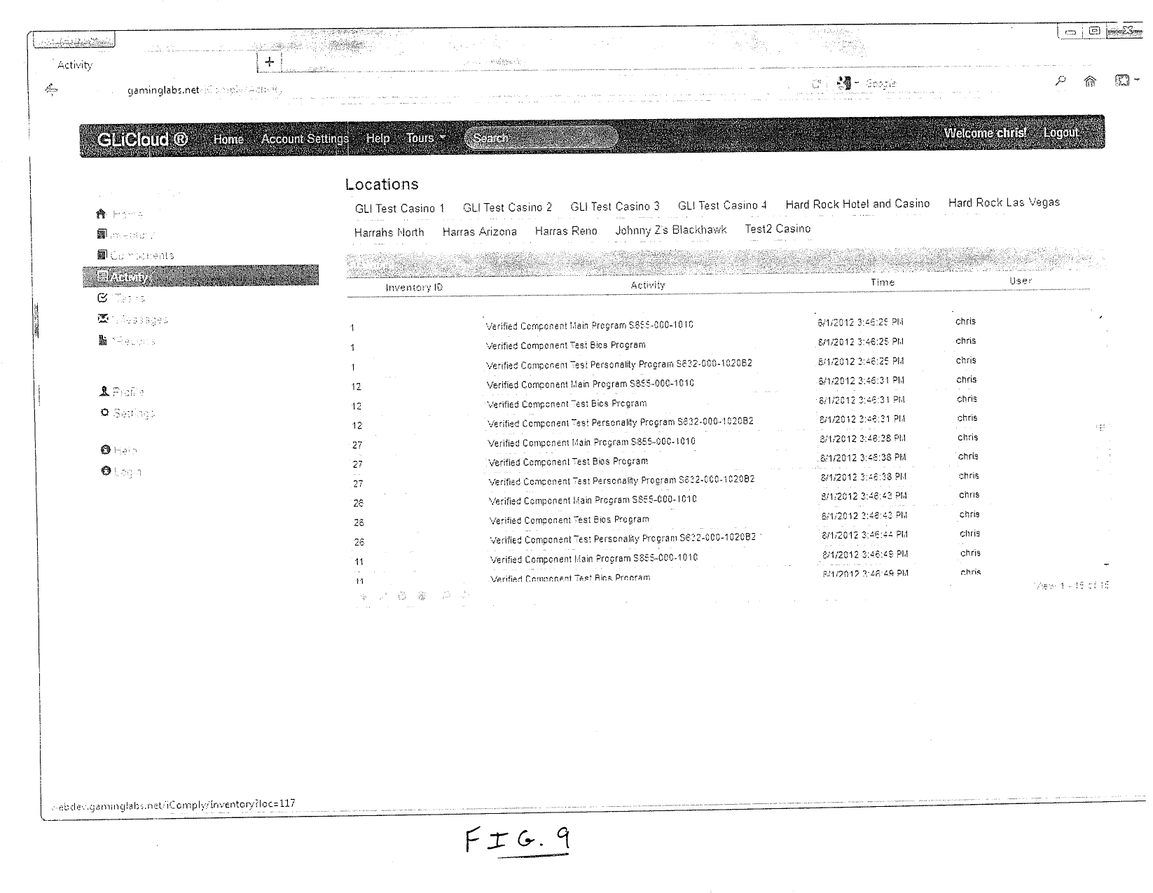

Additionally, since the machines in casinos are under constant surveillance, and monitored by regulatory bodies, all of the activity on the machine is also stored in an activity log associated with each gaming machine component, an example of which is depicted in FIG. 9.

Although use of a communication device 202, as described in FIG. 2, is presented herein, the present invention is not limited in this regard. The methods are useful with alternative devices as well, such as portable computer applications, PDA applications, and tablet computing devices, and the like. The methods described in FIGS. 4-5 may be performed by an electronic circuit of the communication device 202, with the assistance of the servers 110, 106, 108, 112, and databases 102, 104, 106, over the Internet or another communications network, consistent with an embodiment of the invention.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the methods without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A method of authenticating an inventory list of the components installed on casino and Internet gambling devices, the method comprising:
receiving, from an input device, an input signal indicating the identity and location of a gambling device, and an electronic signature of each installed component;
receiving, by an electronic circuit in communication with the input device, the electronic signature and software components which should be installed on the gambling device;
if the electronic signature of the components match the received electronic signature of the what should be installed on the gambling device, sending a confirmation to an inventory database indicating the installed software is authenticated;
else if the electronic signature of the components do not match the received electronic signature of the what should be installed on the gambling device, sending a message to an operator indicating the correct software is not installed.

2. The method according to claim 1, wherein the electronic signature is generated using a customized seed.

3. The method according to claim 1, further comprising:
generating by the electronic circuit a record of all activities regarding a gambling device; and,
sending the record to an inventory database.

4. The method according to claim 3, further comprising receiving by the electronic circuit a report of all records pertaining to the gambling device from the inventory database.

5. The method according to claim 1, wherein the identity of the gambling device is determined automatically by the electronic circuit.

6. The method according to claim 1, further comprising:
capturing a live video of the gambling device using a camera associated with the electronic circuit; and,
streaming the captured video to a live video feed.

7. The method according to claim 1, wherein the message sent to the operator includes the description and electronic signature of the correct components that should be installed on the gambling device.

8. A method for providing a casino operator with one or more messages indicating problem software installations on one or more gambling devices, the method comprising:
receiving into an inventory database component the identity and signature of all components installed on the one or more gambling device, the inventory database component comprising a database and an associated electronic circuit;
comparing, by the electronic circuit, the received identity and signature of all installed components with the identity and signature of the approved components for the jurisdiction; and
reporting, by the electronic circuit, to the casino operator all components whose signature does not match the signature of an approved component.

9. A system for authenticating an inventory list of the components installed on casino gambling devices, the system comprising
a GAT server component for providing digital images of all components, digital signatures of all components, and unique regulator signatures of all components;
an inventory database component for providing gambling device locations, listing of components in each gambling device, and a record of activities involving each gambling device;
a submissions database component for providing regulatory approval status of components in one or more jurisdiction;
a document repository component for providing payglass, par sheets and game information for each gambling device; and,
a mobile application component comprising an electronic circuit, and an input device, with at least one electronic circuit configured to perform the following operations:
receiving, from the input device, an input signal indicating the identity and location of a gambling device, and an electronic signature of each installed component;
receiving, by the electronic circuit, the electronic signature and software components which should be installed on the gambling device;
if the electronic signature of the components match the received electronic signature of the what should be installed on the gambling device, sending a confirmation to the inventory database component indicating the installed software is authenticated;
else if the electronic signature of the components do not match the received electronic signature of the what should be installed on the gambling device, sending a confirmation to the inventory database component indicating the correct software is not installed.

10. The system according to claim 9, wherein the electronic signature is generated using a customized initialization parameter.

11. The system according to claim 9, further comprising:
generating by the electronic circuit a record of all activities regarding a gambling device; and,
sending the record to the inventory database component.

12. The system according to claim 11, further comprising receiving by the electronic circuit from the document repository component a report of all records pertaining to the gambling device from the inventory database.

13. The system according to claim 9, wherein the identity of the gambling device is determined automatically by the electronic circuit.

14. The system according to claim 9, further comprising:
capturing a live video of the gambling device using a camera associated with the electronic circuit; and,
streaming the captured video to a live video feed.
